(19) United States
(12) Patent Application Publication
(10) Pub. No.: US 2026/0301521 A1
(43) Pub. Date: Oct. 1, 2026

(54) GAME SYSTEM FOR PLAYING A GAMBLING GAME AND METHOD OF PROVIDING VARIABLE PAYOUT ODDS VALUES FOR GAMBLING GAME

(71) Applicant: JUMBO TECHNOLOGY CO., LTD., Taichung City (TW)

(72) Inventors: Shun-Tsung HSU, Taichung City (TW); Chang-Yi WANG, Taichung City (TW)

(21) Appl. No.: 19/700,981

(22) Filed: Jun. 8, 2026

Related U.S. Application Data
(63) Continuation-in-part of application No. 19/193,645, filed on Apr. 29, 2025.
Application No. 19/193,645 is a continuation of application No. 19/072,196, filed on Mar. 6, 2025, now abandoned.
Application No. 19/072,196 is a continuation-in-part of application No. 17/915,980, filed on Apr. 1, 2020, now Pat. No. 12,249,214.
Application No. 19/072,196 is a continuation-in-part of application No. 18/251,793, filed on Dec. 3, 2020.

(51) Int. Cl. G07F 17/32; G06T 7/70

(52) U.S. Cl. CPC G07F 17/323; G06T 7/70; G07F 17/3209; G07F 17/3211

(57) ABSTRACT

A game system for playing a gambling game includes a game result generator, a payout unit, a memory unit storing variable odds sets that respectively correspond to variable options and that each includes variable payout odds values, and a processor configured to: designate specific N number(s) respectively corresponding to N betting area(s) among the M betting areas as lucky number(s); obtain one of the variable options corresponding to the value N, and read a corresponding variable odds set from the memory unit; determine an adjusted payout odds value from among corresponding variable payout odds values; replace the default payout odds value of each of the N betting area(s) with the respective adjusted payout odds value; calculate a payout amount based on a game result, and either the default payout odds values or the adjusted payout odds value(s); and control the payout unit to provide a payout.

### CROSS-REFERENCE TO RELATED APPLICATION

This is a continuation-in-part of U.S. patent application Ser. No. 19/193,645, filed on Apr. 29, 2025, which is a continuation of co-pending U.S. patent application Ser. No. 19/072,196, filed on Mar. 6, 2025, which is:
a continuation-in-part of U.S. patent application Ser. No. 17/915,980, filed on Sep. 29, 2022, which is a national stage entry of International Application No. PCT/CN2020/082704, filed on Apr. 1, 2020; and
a continuation-in-part of U.S. patent application Ser. No. 18/251,793, filed on May 4, 2023, which is a national stage entry of International Application No. PCT/CN2020/133669, filed on Dec. 3, 2020.

The aforesaid applications are incorporated by reference herein in their entirety.

### FIELD

The disclosure relates to a game system for playing a gambling game and a method of providing variable payout odds values for a gambling game.

### BACKGROUND

A conventional single-zero roulette game system typically provides a fixed 35:1 payout for straight-up bets. Recently, a dynamic payout model has been implemented to increase gameplay volatility.

In the dynamic payout model, the system designates selected “lucky number(s)” corresponding to one or more of a plurality of betting areas, and assigns enhanced multiplier(s) (e.g., 35× to 500×) thereto. To stabilize the RTP (Return to Player) and to ensure a spatially uniform distribution of variable odds, the system randomizes each of 37 betting areas via a pseudo-random number generator. Consequently, the implementation of this dynamic model imposes a substantial computational load on the system, as the entire payout table must be recalculated and updated in real time upon each assignment of a lucky number and its respective multiplier.

### SUMMARY

Therefore, an object of the disclosure is to provide a game system for playing a gambling game and a method of providing variable payout odds values for a gambling game that can alleviate at least one of the drawbacks of the prior art.

According to an aspect of the disclosure, the game system is for playing a plurality of rounds of the gambling game that has M betting areas respectively having a plurality of default payout odds values, where M>1. The game system includes a game result generator, a payout unit, a memory unit and a processor.

The game result generator is configured to generate a game result for each round of the gambling game.

The payout unit is configured to perform one of dispensing a payout and crediting a payout to a player playing the gambling game.

The memory unit stores a plurality of variable odds sets respectively corresponding to a plurality of variable options. Each of the plurality of variable odds sets includes a plurality of variable payout odds values that are respectively assigned with a plurality of probabilities of appearance.

The processor is communicatively connected to the game result generator, the payout unit and the memory unit, and is configured to: designate specific N number(s) respectively corresponding to N betting area(s) among the M betting areas as lucky number(s), where value N is at least 1 but less than value M; obtain one of the plurality of variable options corresponding to the value N, and read a corresponding one of the plurality of variable odds sets from said memory unit according to said one of the plurality of variable options; determine, in response to receiving a wagering completion signal, for each of the N betting area(s), an adjusted payout odds value from among the plurality of variable payout odds values of the corresponding variable odds set according to their probabilities of appearance; replace, for each of the N betting area(s), the default payout odds value with the respective adjusted payout odds value; calculate, for each round of the gambling game, a payout amount based on the game result, and one of the default payout odds values and the adjusted payout odds value(s) of the M betting areas, depending on which odds apply to the game result; and control the payout unit to perform one of dispensing the payout and crediting the payout based on the payout amount thus calculated.

According to another aspect of the disclosure, the method is to be implemented by the game system and includes steps of, by the processor:
designating specific N number(s) respectively corresponding to N betting area(s) among the M betting areas as lucky number(s), where value N is at least 1 but less than value M;
obtaining one of the plurality of variable options corresponding to the value N, and reading a corresponding one of the plurality of variable odds sets from the memory unit according to said one of the plurality of variable options;
determining, in response to receiving a wagering completion signal, for each of the N betting area(s), an adjusted payout odds value from among the plurality of variable payout odds values of the corresponding variable odds set according to their probabilities of appearance;
replacing, for each of the N betting area(s), the default payout odds value with the respective adjusted payout odds value;
calculating, for each round of the gambling game, a payout amount based on the game result, and one of the default payout odds values and the adjusted payout odds value(s) of the M betting areas, depending on which odds apply to the game result; and
controlling the payout unit to perform one of dispensing the payout and crediting the payout based on the payout amount thus calculated.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a game system for playing a gambling game according to an embodiment of the present disclosure.

FIG. 2 is a schematic diagram illustrating a betting board of a roulette game.

FIG. 3 is a schematic diagram illustrating the adjusted payout odds value and default payout odds values respectively of the betting areas.

FIG. 4 is a flow chart illustrating a gameplay procedure of a game system according to an embodiment of the present disclosure.

FIG. 5 is a schematic diagram illustrating the betting board in FIG. 3 when N is 1 and a default payout odds value of a selected area is replaced with an adjusted payout odds value.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

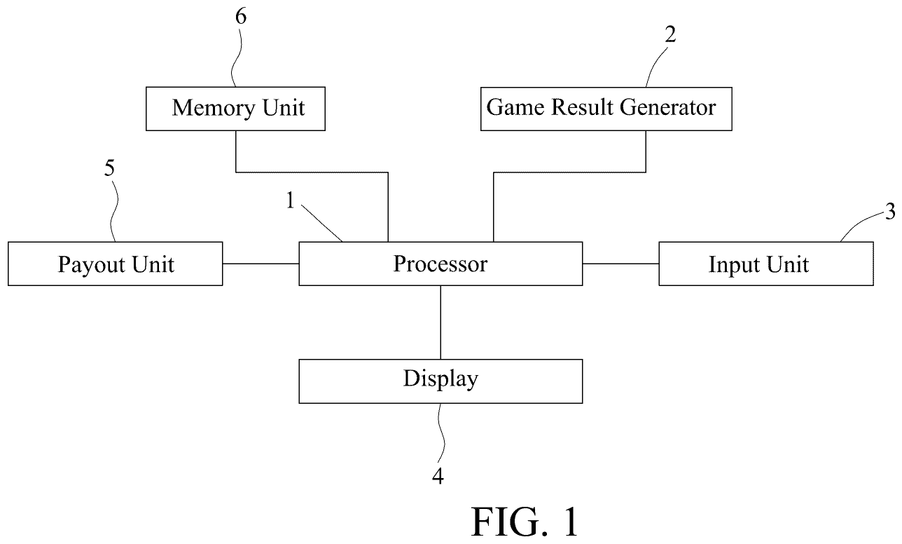

Referring to FIG. 1, a game system 100 for playing a plurality of rounds of a gambling game according to an embodiment of the present disclosure includes a processor 1, and a game result generator 2, an input unit 3, a display 4, a payout unit 5 and a memory unit 6 that are communicatively connected to the processor 1. The gambling game corresponds to the game result generator 2. The gambling game may include, but is not limited to, a roulette game, a baccarat game, or a Sic Bo game. For illustration purposes, the roulette game is used hereinafter as an example of the gambling game currently being played to describe the game system 100.

In this embodiment, the processor 1 may include, for example, at least one of, a multi-core processor, a dual-core mobile phone processor, a microprocessor, a digital signal processor (DSP), a field programmable gate array (FPGA) and an application-specific integrated circuit (ASIC). For example, the processor 1 may be exemplified as a central processing unit (CPU), a micro-processing unit (MPU), a graphics processing unit (GPU), a tensor processing unit (TPU), or a combination thereof, but the processor 1 is not limited to such.

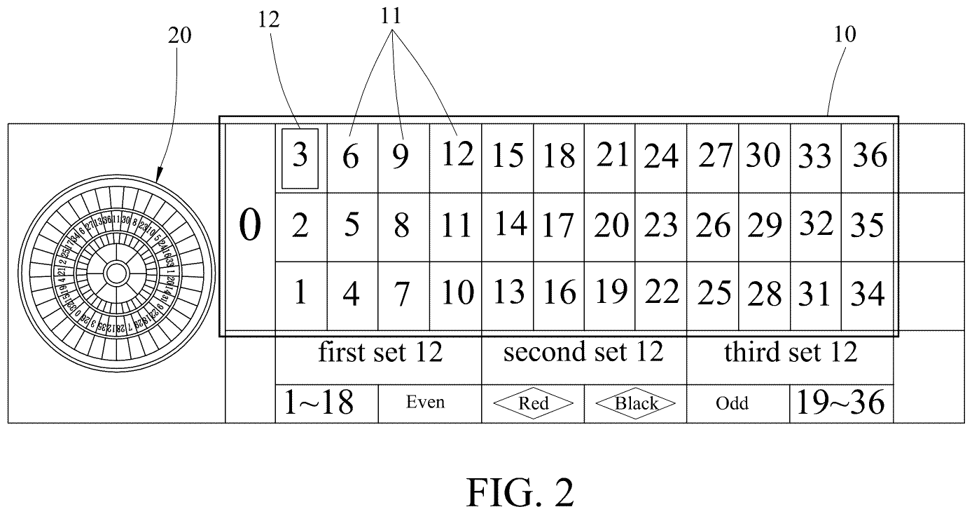

The game result generator 2 is configured to randomly generate a game result in each round of the gambling game. In this example, the game result generator 2 is exemplified as a roulette device (not shown) that includes a European-style layout roulette wheel 20 (as shown in FIG. 2) with numbers from “0” to “36” and a roulette ball (not shown) for playing the roulette game. Specifically, in this example, the game result generator 2 generates the game result that is defined by the pocket into which the roulette ball falls after the roulette wheel stops rotating, which corresponds to one of the numbers from “0” to “36”.

The input unit 3 is provided for allowing a player to perform operations thereon. In this embodiment, the input unit 3 may be embodied using a keyboard, a gaming console, or a touchscreen module, but is not limited thereto.

The display 4 is configured to display a betting board 10 (as shown in FIG. 2) that has M betting areas 11, where M>1. For illustration purposes, only betting areas that correspond to single bets in the roulette game will be described hereinafter for the sake of brevity. That is to say, in this example, the M betting areas 11 correspond respectively to the numbers from “0” to “36” (i.e., M=37). In one embodiment, the input unit 3 may be integrated with the display 4 as a single unit (e.g., a touchscreen display) to provide both input and display functions for the player to play the gambling game; however, the disclosure is not limited in this respect.

The payout unit 5 is configured to dispense or credit a payout to the player playing the gambling game. In this embodiment, the payout unit 5 may include one or more devices configured to provide the payout to the player, such as a coin hopper, a bill dispenser, a ticket printing device, an electronic account crediting system, or the like.

The memory unit 6 stores a plurality of variable odds sets respectively corresponding to a plurality of variable options. Each of the plurality of variable odds sets includes a plurality of variable payout odds values that are respectively assigned with a plurality of probabilities of appearance (POAs). An example of the variable odds sets that is to be used to describe the game system 100 in this disclosure is shown in Table 1 below.

TABLE 1

| Vari- | | | | Aver- |
|---|---|---|---|---|
| able | Value | Variable | Probabilities | age |
| Option | N | Odds Sets | of Appearance | Odds |
| I | 1 | (60, 80, 250, 500) | (37%, 23%, 20%, 20%) | 190.6 |
| II | 1 | (35, 70, 200, 5000) | (80%, 12%, 6%, 2%) | 148.40 |
| III | 2 | (60, 80, 250, 500) | (55%, 20%, 15%, 10%) | 136.5 |
| IV | 2 | (35, 65, 200, 1200) | (75%, 15%, 8%, 2%) | 76 |
| V | 3 | (60, 80, 250, 500) | (70%, 15%, 10%, 5%) | 104 |
| VI | 3 | (35, 70, 200, 900) | (75%, 15%, 8%, 2%) | 70.75 |
| VII | 4 | (60, 80, 250, 500) | (84%, 10%, 5%, 1%) | 76 |
| VIII | 4 | (32, 55, 150, 800) | (75%, 15%, 8%, 2%) | 60.25 |

Table 1 illustrates eight variable options I, II, III, IV, V, VI, VII, and VIII, where one single value of N corresponds to multiple variable options, and each variable option includes four variable payout odds values (e.g., 60, 80, 250, 500) and their corresponding probabilities of appearance (POAs) (e.g., 70%, 15%, 10%, 5%). The advantage of a single N corresponding to multiple variable options is that it grants operators the flexibility to either restrict use to a specific option, depending on local regulations or operational needs, or to retain all available options. It is noted that in this disclosure, one single value of N may correspond to only one variable option, and the number of the variable odds sets and the number of the variable payout odds values are not limited to such. For each of the variable odds sets, a sum of the POAs is equal to 100% (e.g., 70%+15%+10%+5%=100% for variable option V). In Table 1, the variable payout odds values are arranged in increasing order of magnitude (e.g., 60, 80, 250, 500), and the POAs respectively of the variable payout odds values decrease as the magnitude increases, but the disclosure is not limited in this respect. That is, the variable payout odds values may be arranged in ascending, descending, or any random order of magnitude, with their respective POAs mapped accordingly in an equally flexible sequence. Each of the variable options I, II, III, IV, V, VI, VII, and VIII has an average odds value that is calculated by summing, for the respective one of the variable odds sets, products of the variable payout odds values respectively with the POAs (e.g., the average odds value for the variable option V=(60×70%)+(80×15%)+(250×10%)+(500×5%)=104).

In this embodiment, each of the M betting areas 11 has a default payout odds value. In this example, the default payout odds value is 29, which is lower than the payout odds value for straight-up bets in a conventional roulette game (i.e., 35), where each bet corresponds to a specific number from “0” to “36”. Specifically, the default payout odds value is predetermined such that a return to player (RTP) of the gambling game is below 100%, where the RTP of the gambling game is a percentage of an amount wagered by the player that the player receives back on average and over a large number of rounds.

Referring to Table 1 above, each of the variable options indicates a value N that represents N betting area(s) among the M betting areas 11 whose default payout odds value(s) is/are to be replaced with variable payout odds value(s), where 1≤N<M. Generally, the average odds value of each of the variable options decreases as N increases.

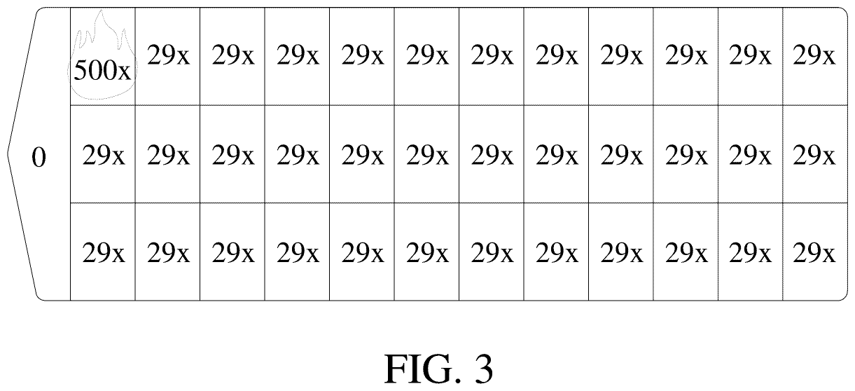

Further referring to FIG. 3, by virtue of the abovementioned arrangements, in a single round of the gambling game, there is a possibility that, when the variable option I is applied, a “500” payout odds value may appear in “one” of the M betting areas 11. However, when the gambling game is played over a relatively long period of time and over a relatively large amount of rounds, the RTP of the gambling game may be calculated using the following formula.

$$RTP of the gambling game = [ 1 + ( ( default payout odds value \times 36 ) + ( average odds value \times 1 ) ) / 37 ] / 37 = [ 1 + ( ( 29 \times 36 ) + ( 190.6 \times 1 ) ) / 37 ] / 37 \approx [ 1 + 33.4 ] / 37 \approx 92.9 \% .$$

That is to say, on average and over a large number of rounds, the gambling game may maintain a theoretical RTP of approximately 93%, thus incentivizing players with high-multiplier potentials while guaranteeing operator returns. It should be noted that the above calculation of the RTP is exemplified by applying the variable option I, wherein the gambling gaming is a European-style layout roulette wheel, and the bet type is a “straight-up bet” (a single bet wagering on a single number), but the present invention is not limited thereto.

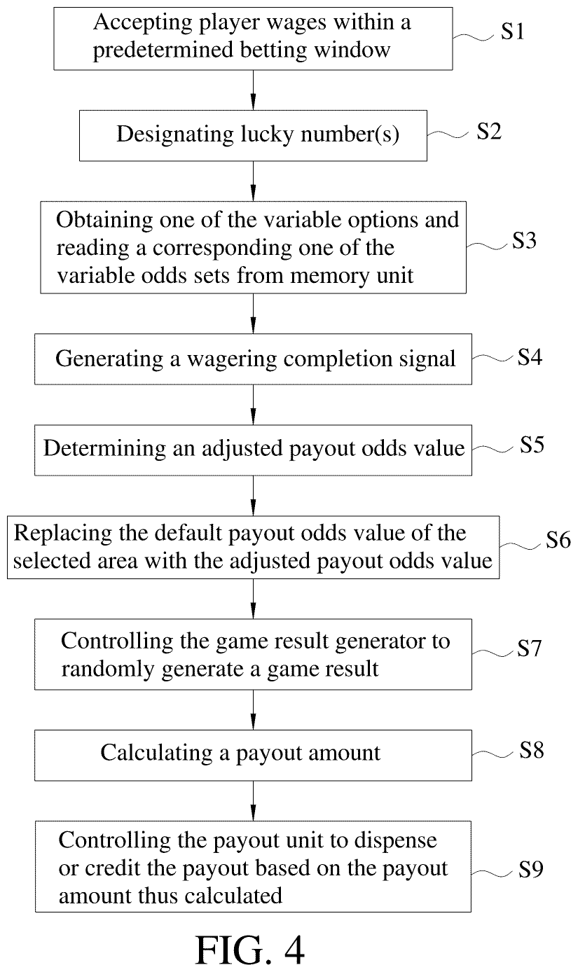

Referring to FIG. 4, a method of providing variable payout odds values for a gambling game includes steps S1 to S9. The method is implemented by the game system 100.

In step S1, the processor 1 enables the input unit 3 to accept player wagers within a predetermined betting window.

In step S2, the processor 1 designates specific N number(s) respectively corresponding to the N betting area(s) as lucky number(s). Specifically, continuing with the examples in Table 1, the processor 1 may first randomly determine the value N, and subsequently designates the specific N numbers from “0” to “36” as the lucky number(s). It should be noted that the specific implementation of the processor 1 designating lucky number(s) is not limited to the examples provided above. In some embodiments, the processor 1 first randomizes the order of the numbers respectively corresponding to the M betting areas 11 before randomly determining the value N, then designates the first N number(s) as the lucky number(s). In some other embodiments, the processor 1 may directly and randomly select N lucky number(s) from the M betting areas 11.

In step S3, further referring to FIG. 2, the processor 1 obtains one of the variable options corresponding to the value N, and reads a corresponding one of the variable odds sets from the memory unit 6 according to said one of the variable options thus obtained. In cases where a one-to-one mapping exists between the values N and the variable options, the processor 1 automatically determines the corresponding variable option based on the value N. However, in the event that the value N corresponds to multiple variable options (e.g., N=1 maps to several variable options, as illustrated in Table 1), the processor 1 may further randomly select a specific variable option from those associated with the value N, thereby obtaining a final selection from the plurality of variable options.

In step S4, in response to the predetermined betting window having lapsed, the input unit 3 generates a wagering completion signal that includes information of the wager placed by the player and said one of the variable options thus obtained.

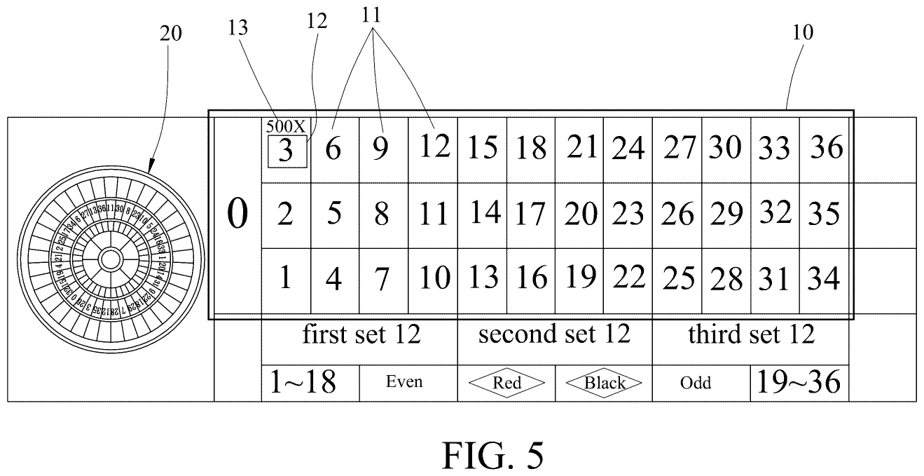

In step S5, in response to receiving the wagering completion signal, the processor 1 determines, for each of the betting area(s) corresponding to the lucky number(s) (i.e., the N betting area(s) 12), an adjusted payout odds value 13 (exemplified in FIG. 5) from among the four variable payout odds values (i.e. 60, 80, 250, 500) of said corresponding variable odds set according to their probabilities of appearance (i.e. 70%, 15%, 10%, 5%).

In step S6, the processor 1 replaces, for each of the default payout odds value(s) of the N betting area(s) 12, with the respective adjusted payout odds value 13, while maintaining the default payout odds values for the remaining ones of the M betting areas 11. In this embodiment, the processor 1 then controls the display 4 to display the adjusted payout odds value 13 on the N betting area(s) 12. For example, as shown in FIGS. 3 and 5, when N=1, the adjusted payout odds value 13 for the N betting area 12 is 500×, while the remaining ones of the M betting areas 11 each have the default payout odds values of 29.

In step S7, the processor 1 controls the game result generator 2 to randomly generate a game result for the current round of the gambling game.

In step S8, the processor 1 calculates, for the current round of the gambling game, a payout amount based on the game result, and either the default payout odds values or the adjusted payout odds value 13 of the M betting areas 11 (i.e., the corresponding odds), depending on which odds apply to the game result.

In step S9, the processor 1 controls the payout unit 5 to dispense or credit the payout based on the payout amount thus calculated.

In summary, the processor 1 obtains one of the variable options that indicates the value N representing the N betting area(s), and determines, for each of the N betting area(s) the adjusted payout odds value 13, while maintaining the default payout odds values for the remaining ones of the M betting areas. By virtue of the abovementioned arrangement, the processor 1 may only need to perform operation N time(s) to determine the N number of adjusted payout odds value(s), which significantly reduces operation power and time required of the processor 1. In other words, according to the present disclosure, the processor 1 only needs to designate N lucky number(s), obtain a corresponding variable option for each lucky number, and subsequently determine the adjusted payout odds value according to the variable option, thereby significantly reducing the computational load compared to conventional methods.

In addition, by virtue of adjusting the default payout odds values, the variable payout odds values and their corresponding POAs, the present disclosure is able to provide the player with a possibility of having relatively higher payout odds values as compared to conventional payout odds values while maintaining profitability over time.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A game system for playing a plurality of rounds of a gambling game, the gambling game having M betting areas that respectively have a plurality of default payout odds values, where M>1, said game system comprising:
a game result generator configured to generate a game result for each round of the gambling game;
a payout unit configured to perform one of dispensing a payout and crediting a payout to a player playing the gambling game;
a memory unit storing a plurality of variable odds sets respectively corresponding to a plurality of variable options, each of the plurality of variable odds sets including a plurality of variable payout odds values that are respectively assigned with a plurality of probabilities of appearance; and
a processor communicatively connected to said game result generator, said payout unit and said memory unit, and configured to
designate specific N number(s) respectively corresponding to N betting area(s) among the M betting areas as lucky number(s), where value N is at least 1 but less than value M,
obtain one of the plurality of variable options corresponding to the value N, and read a corresponding one of the plurality of variable odds sets from said memory unit according to said one of the plurality of variable options,
determine, in response to receiving a wagering completion signal, for each of the N betting area(s), an adjusted payout odds value from among the plurality of variable payout odds values of said corresponding variable odds set according to their probabilities of appearance,
replace, for each of the N betting area(s), the default payout odds value with the respective adjusted payout odds value,
calculate, for each round of the gambling game, a payout amount based on the game result, and one of the default payout odds values and the adjusted payout odds value(s) of the M betting areas, depending on which odds apply to the game result, and
control said payout unit to perform one of dispensing the payout and crediting the payout based on the payout amount thus calculated.

2. The game system as claimed in claim 1, wherein said processor is configured to designate the lucky number(s) by first randomly determining the value N, and subsequently designating the specific N numbers corresponding to the N betting area(s) as the lucky number(s).

3. The game system as claimed in claim 1, wherein said processor is configured to designate the lucky number(s) by first randomizing the order of numbers respectively corresponding to the M betting areas, then randomly determining the value N, and then designating the first N number(s) as the lucky number(s).

4. The game system as claimed in claim 1, wherein said processor is configured to designate the lucky number(s) by directly and randomly selecting N lucky number(s) from among the M betting areas.

5. The game system as claimed in claim 1, wherein each of the plurality of variable options has an average odds value that is calculated by summing, for the respective one of the plurality of variable odds sets, products of the plurality of variable payout odds values respectively with the probabilities of appearance.

6. The game system as claimed in claim 5, wherein the plurality of variable options respectively indicate a plurality of values of N arranged in increasing order of magnitude, and the average odds values respectively of the plurality of variable options decrease as the magnitude of N increases.

7. The game system as claimed in claim 1, further comprising:
an input unit communicatively connected to said processor,
wherein said input unit is configured to, in response to a predetermined betting window having lapsed, generate the wagering completion signal.

8. A method of providing variable payout odds values for a gambling game, said method being implemented by the game system as claimed in claim 1 and comprising steps of, by the processor:
designating specific N number(s) respectively corresponding to N betting area(s) among the M betting areas as lucky number(s), where value N is at least 1 but less than value M;
obtaining one of the plurality of variable options corresponding to the value N, and reading a corresponding one of the plurality of variable odds sets from the memory unit according to said one of the plurality of variable options;
determining, in response to receiving a wagering completion signal, for each of the N betting area(s), an adjusted payout odds value from among the plurality of variable payout odds values of the corresponding variable odds set according to their probabilities of appearance;
replacing, for each of the N betting area(s), the default payout odds value with the respective adjusted payout odds value;
calculating, for each round of the gambling game, a payout amount based on the game result, and one of the default payout odds values and the adjusted payout odds value(s) of the M betting areas, depending on which odds apply to the game result; and
controlling the payout unit to perform one of dispensing the payout and crediting the payout based on the payout amount thus calculated.

9. The method as claimed in claim 8, wherein the step of designating the lucky number(s) includes first randomly determining the value N, and subsequently designating the specific N numbers corresponding to the N betting area(s) as the lucky number(s).

10. The method as claimed in claim 8, wherein the step of designating the lucky number(s) includes first randomizing the order of numbers respectively corresponding to the M betting areas, then randomly determining the value N, and then designating the first N number(s) as the lucky number(s).

11. The method as claimed in claim 8, wherein the step of designating the lucky number(s) includes directly and randomly selecting N lucky number(s) from among the M betting areas.

12. The method as claimed in claim 8, wherein each of the plurality of variable options has an average odds value that is calculated by summing, for the respective one of the plurality of variable odds sets, products of the plurality of variable payout odds values respectively with the probabilities of appearance.

13. The method as claimed in claim 12, wherein the plurality of variable options respectively indicate a plurality of values of N arranged in increasing order of magnitude, and the average odds values respectively of the plurality of variable options decrease as the magnitude of N increases.

14. The method as claimed in claim 8, the game system further including an input unit communicatively connected to the processor, the method further comprising a step of:
generating, by the input unit, the wagering completion signal in response to a predetermined betting window having lapsed.
